(19) United States
(12) Patent Application Publication
(10) Pub. No.: US 2008/0248770 A1
(43) Pub. Date: Oct. 9, 2008

(54) BROADBAND RECEPTION SYSTEM

(76) Inventors: Micha SCHULTZ, Hildesheim (DE); Oliver BUCHEL, Bad Salzdetfurth (DE); Christian HEUER, Lamspringe (DE)

Correspondence Address: COLLARD & ROE, P.C., 1077 NORTHERN BOULEVARD, ROSLYN, NY, 11576, US

(21) Appl. No.: 12/098,596

(22) Filed: Apr. 7, 2008

Related U.S. Application Data
(60) Provisional application No. 61/042,871, filed on Apr. 7, 2008.

(30) Foreign Application Priority Data
Apr. 5, 2007 (DE) 10 2007 016 928.2
Mar. 1, 2008 (DE) 10 2008 012 127.4

(51) Int. Cl. H04B 1/18; H04B 1/10

(52) U.S. Cl. 455/188.1; 455/307

(57) ABSTRACT

A reception system is proposed which is intended for receiving radio broadcasting in the AM and FM bands having an antenna coupled to an analog part on the input side, for receiving a complete reception band. The system also has a frequency selection module and a digital part that is set up to output a demodulated audio signal. The selection module comprises, as seen in the signal flow, of a filter, an attenuation element that can be regulated, a fixed amplifier, and a further filter. The output side band of the analog part provides a band limited and level-regulated signal that is sampled in an analog to digital converter at a frequency fₛ so that sub-sampling is employed for direct digitalization of the FM band. Sub-sampling is used in relationship to a useful band, wherein this useful band lies completely in the second Nyquist zone. Thus, in this case, fₛ>fₘₐₓ and fₛ/2<fₘᵢₙ applies. The selected structure of the selection module allows the use of this reception system also for direct sampling in the AM band or also in other frequency bands where sub-sampling is not possible. This system has distinct advantages because of the lower hardware expenditure of the analog part, and the lower insertion loss of the front-end filters, better sensitivity and better protection against aliasing.

### CROSS REFERENCE TO RELATED APPLICATIONS

This application hereby claims priority from German Application DE 10 20070169282 filed on Apr. 5, 2007 the disclosure of which is hereby incorporated herein by reference in its entirety, this application is also a non-provisional application that claims priority from provisional application Ser. No. 61/042,871 filed on Apr. 7, 2008 the disclosure of which is hereby incorporated herein by reference in its entirety.

### BACKGROUND

The invention relates to a broadband reception system. Modern receivers are designed as homodyne or heterodyne receivers, and they are employed for stationary use, and for use in vehicles. These receivers have in common that the reception frequency of a signal is mixed with an adjustable oscillator frequency generated in the receiver. Thus, the desired signal is converted to a fixed intermediate frequency (IF), which is subsequently digitalized and processed further. Thus, in principle a broad frequency band can be received and the demands on performance and especially the sampling rate and the resolution of an ADC (analog/digital converter), are independent of the reception frequency selected, in each case. This is a result of the mixing stage that precedes digitalization and that provides the fixed intermediate frequency. The demands on the ADC are further reduced by means of the choice of a low intermediate frequency, and a good selection of a band or channel, so that a good utilization of its dynamic range is achieved.

However, this known concept shows performance degradation in many cases, depending on the specific embodiment used, which can be caused by phase noise of the local oscillator, reception of unwanted spectral components at image frequencies due to harmonics of the oscillator, I-Q imbalance problems, or by an incomplete mirror image or harmonic-frequency suppression by the filters that precede the mixing stage. In addition, insertion loss of the mixing stage leads to a loss in sensitivity and power. In order to achieve a correction or at least a reduction of the resulting distortions caused by these insufficiencies, extensive and expensive hardware countermeasures are necessary.

Also, with this receiver architecture, in most cases the selection of only one channel is provided, to keep the demands on the subsequent ADC low. Since for each transmission standard, a different channel bandwidth is used, switching to another standard requires the use of a different channel filter which means that the hardware of the receiver system needs to be changed. The flexibility of this known system is therefore strongly limited.

Since only one channel can be received with this receiver architecture, special measures must be taken in the case of those applications in which several channels must be received at the same time. For example, in the case of radio receivers used in vehicles, there is a need to receive more than one channel at the same time. In these cases, typically three receiver branches, implemented in hardware, of which each is tuned into a different reception channel, in each instance, are regularly active.

The first branch is tuned into the channel that is being listened to at the moment, a second branch is searching for alternative frequencies of the same program content, and a third branch is set to traffic radio applications. The use of the known techniques leads to setting up three independent reception branches, each of which has a mixing stage, a channel selection circuit or in other words an intermediate frequency filter adapted to the bandwidth of the received service, and an ADC, so that in total, there is a correspondingly increased hardware expenditure.

To meet the need for the parallel reception of several channels, specifically without the increased number of reception branches of the type stated above, and to avoid a correspondingly increased hardware expense, there is a trend in the case of digital radio receivers, of moving the interface between the analog and digital signal processing as close to the antenna as possible. This trend is to guarantee a maximum of flexibility of the reception system. Here, the function of the digital hardware is defined by means of software, in the final analysis, so that if necessary, it can be reprogrammed without much effort, so that it can be adapted to different standards.

The concept of a reception system, in which digitalization of received analog signals takes place in the vicinity of the antenna, and thus avoiding an analog mixing stage, is known, for example, from “A Software Defined Multistandard Tuner Platform for Automotive Applications,” T. Müller, M. Sliskovic, J.-F. Luy, H. Schöpp, Zeitschrift Frequenz, Berlin, Vol. 68, Part 5/6, pages 136 to 139, Fachverlag Schiele & Schön GmbH, 2004. With the there proposed direct sampling concept, all of the channels of the FM ultra-short-wave radio band are selected after broadband filtering by means of a multistage ultra-short-wave band filter, and passed to an analog to digital converter (ADC) after level regulation, so that the entire ultra-short-wave band is present in digital form at the output of the ADC. This known reception system would allow parallel reception of any desired number of channels or standards, assuming a signal processing unit (DSPU) having sufficient performance capacity is present.

The concept of direct sampling presented there employs sub-sampling, because its sampling rate is fₛ=76.8 MHz, so that the ultra-short-wave (FM) radio frequency band of 87.5 MHz to 108 MHz that is digitalized, lies completely in the 3^{rd} Nyquist band, and it is centered relative to the band limits. Selection and aliasing suppression take place by means of cascaded band-pass filters and amplifiers, and the gain of the amplifiers is digitally programmable.

Because no analog mixing stage is present in this concept of direct sampling, the problems mentioned above, which are related to mixing in the analog domain, are avoided. There is also an increased flexibility for the case of a change in standard. However, the selection of the sampling rate for digitalization of the ultra-short-wave radio band is disadvantageous, since this requires a high level of filter measures, to fulfill the aliasing suppression requirements for digitalization of this band. This leads to great hardware expenditure, and under some circumstances, to distortion susceptibility of the system. Extensive filter measures furthermore lead to increased insertion loss in the transient band, so that, depending on the positioning of the filters in the analog reception path, either the sensitivity of the system is reduced, or the linearity demands on analog front-end amplifiers are increased.

A further problem results, with this proposed concept of direct sampling since a fixed gain amplifier is placed adjacent to the antenna in the progression of the signal path. This can lead to distortion in the case of strong signal levels which occurs for example for reception of near-by transmitter stations. For high reception levels, the non-linear behavior of the amplifier leads to intermodulation products or harmonic interference which falls into the useful signal band and degrades the reception quality.

The invention provides a reception system with direct digitalization, having simple system architecture and, at the same time, great performance capabilities and which allows independence from standards, in a simple manner. The reception system uses the techniques of direct sampling of a complete frequency band, for the purpose of conversion to a digital form, as well as allowing parallel reception by means of one or multiple tuners implemented in and controlled exclusively by means of software.

According to the invention, the central ADC (analog/digital converter), particularly its sampling frequency fₛ, which must be seen in relationship with the useful band to be converted, is essential to the invention. In every case, the analog input signal of the ADC must be band-limited, and care must be taken, by means of a suitable selection of the sampling frequency, to ensure that no interference in the form of aliasing occurs. According to the invention, sub-sampling is used at least for the digitalization of the FM range, so that the useful band to be sampled lies completely in the second Nyquist zone, preferably in its center. This allows a good compromise between the demands on the filter characteristics of the analog part and the performance requirements on the ADC and other components of the digital part. In comparison with known applications of direct sampling of the FM band in the form of sub-sampling, there are lower requirements with regard to the flank steepness of the characteristics of the analog prefilters. Furthermore, there is lower hardware expenditure, and less insertion loss at a comparable receiver sensitivity and great aliasing suppression. Thus, standard filter components can be used within the framework of the analog part of the system. For example, according to the invention, a sampling frequency of 141.5 MHz can be used for direct digitalization of the European ultra-short-wave FM radio band of fₘᵢₙ=87.5 MHz to fₘₐₓ=108 MHz. Deviations from this are permissible, as long as the useful band is in the second Nyquist zone.

The sampling frequency, which is chosen as fₛ=fₘᵢₙ+fₘₐₓ/2, is an optimal frequency that provides that the relative bandwidths of the two transition bands of the filter transfer function (relative lower and relative upper transition band) are the same. The terms relative upper b_{tr,up} and relative lower transition band b_{tr,low} are defined, in each instance, as b_{tr,up}=f_{k,up}/fₘₐₓ and b_{tr,low}=fₘᵢₙ/f_{k,low}, where f_{k,low} is the lower and f_{k,up} is the upper critical cutoff frequency. These critical frequencies (f_{k,low} and f_{k,up}) are frequencies at which signal components fall into the useful band from below or above the useful band (due to aliasing) for the first time. Additionally, a symmetrical characteristic of the filters is additionally advantageous, but not mandatory, for which in this case it applies that the attenuation brought about by the selection module has equal values at the critical frequencies f_{k,low} and f_{k,up}. The proposed symmetrical dimensioning of the filters and the choice of the sampling frequency so that the conditions b_{tr,low}=b_{tr,up} are fulfilled guarantees optimal protection of the useful signal band against interference due to aliasing, accompanied with a simple, low-cost, affordable filter implementation.

Because of the low demands on flank steepness, filters of a low order may be used. To protect the ADC against clipping, an amplifier that can be regulated, or a fixed gain amplifier in combination with an attenuation element that can be regulated, can be used to protect the ADC against clipping. Because of the variable attenuator that precedes the fixed amplifier, the result is achieved that the input of the amplifier is protected against clipping even at the highest signal levels of the antenna. The variable attenuator can either have a continuous or a stepped steering characteristic. The proposed structure of the selection module is particularly advantageous in that it allows this reception system to be used not only in the FM band range, for providing a direct sampling in the manner of sub-sampling, but also in the AM band range, where sub-sampling of the full band is not possible.

The front-end amplifier is dimensioned so that at the output of the analog to digital converter the noise level that is generated by the amplifier in a channel of the useful band, lies less than b 10 dB above, or below the noise level generated by the ADC in this channel. This leads to optimum performance of the direct-sampling system, particularly to an optimal utilization of the dynamic range of the ADC.

Moreover, a transformer providing impedance transformation is located at the input of the ADC, in order to reduce the linearity requirements on the amplifiers in the analog front-end. The impedance transformation between a secondary-side termination resistor, switched in parallel to the ADC input, and the impedance on the transformer primary side, is achieved by using a transformer having a secondary to primary ratio of t>1. If the transformer and the termination resistor are dimensioned appropriately, this transformer arrangement has an inherent voltage amplification, so that the levels at an amplifier, positioned ahead of the transformer in the signal-path, turn out to be less than for an arrangement without a transformer or a transformer with t=1 for equal levels at the ADC input. This leads to less nonlinear distortion and therefore to improved signal quality regarding the linearity of the digitized input signal.

The reception system has a digital part that comprises at least one digital signal processing unit DSPU and at least one digital to analog converter DAC. The DSPU can be configured by software so that there is a selection and demodulation of channels from the useful band on the input side. The DSPU provides multiple tuners by means of software, but also numerous control functions that can also be provided by means of software. Merely as an example, AGC algorithms (automatic gain control) are mentioned, which can be implemented in simple manner by way of software. This particularly relates also to subsequent changes, which would be connected with an unreasonable effort in the case of an implementation in analog technology only.

The invention generally relates to a reception system with direct digitization for the integration of different services into a single system design, such as the handling of FM and AM services, where the AM service is accommodated in the band from 150 kHz to 30 MHz. Furthermore, this innovation enables the concept of a digital antenna and it provides a diversity concept.

The concept of the digital antenna allows parallel reception at a plurality of terminals, so that partial bands or individual channels, or the entire useful bands which are obtained by way of direct sampling, are passed to the terminals by way of the DSPU. In the latter case, all of the AM and FM radio services would be present at every terminal, in parallel, so that every terminal could evaluate and demodulate, i.e. output as many channels as desired, in parallel, by means of several tuners presented by means of software. The concept of the digital antenna therefore offers a maximum of flexibility and reconfigurability, since all of the functions past the antenna output can be provided by means of software, since the entire useful band is digitally available.

In the case of an antenna diversity concept, x signal paths can be assigned to y data streams, i.e. tuners on the DSPU provided by means of software, by way of the DSPU. All of the functions connected with the ongoing evaluation and assignment of tuners and signal paths can be handled by way of the DSPU, using software. Because all functions are implemented in software, this diversity concept with direct sampling offers a maximum of flexibility and a high degree of freedom for the implementation and application of digital algorithms and optimizations.

A further variation of the invention comprises a plurality of ADC units having common sampling frequency fₛ. This reception system setup is used for simultaneous reception in the FM and the AM frequency band range, and it is designed so that the conditions stated initially exist for sub-sampling for the FM frequency band, whereas over-sampling is used for the AM range for this choice of sampling frequency. Sub-sampling over the entire spectrum is not possible in this case. Because of the common sampling frequency, however, both ranges can be operated by means of the same clock generator, e.g. a fixed-frequency oscillator. The advantages of this simple system design and, in particular, of the simple architecture of the analog part, with simultaneously high performance capabilities are also present for the case of over-sampling of the AM frequency band.

The DPSU is used for control of the attenuation element or an amplifier situated in the analog front-end. Control is provided from an AGC algorithm set up in the DSPU, which incorporates an inverse steering curve of the attenuation element, which is stored in digital form in a look-up table (LUT). This ensures that a level change at the input of the ADC, above or over the AGC threshold, for example caused by fading effects in the selected band, can be counter-regulated almost directly and instantly. For this purpose, the amplitude of the level change is determined, and the corresponding value from the LUT, which precisely balances out this level jump, is used for controlling the attenuation element, taking into account the control voltage set at that moment.

Since such an AGC algorithm is based merely on comparison operations and memory access, and no filters that would lead to latency are required, a fast-attack characteristic is achieved in this manner that guarantees good protection of the ADC against clipping. In particular, level increases can be balanced out as quickly as possible and precisely, whereby the reaction time is only dependent on the setting speed resp. reaction time of the attenuation element.

In the case of this AGC concept, a fast-attack approach can be combined with a slow-release, or also a peak-hold, so that good control of the ADC is present at all times. In contrast, it is almost impossible to implement a precise peak-hold function in a hardware-implementation with analog components that can be configured in this desired manner.

This approach contains not only the fast-attack reaction to a level jump above the or over the AGC threshold, but also a peak-hold function, in which the related setting value for the attenuation element that is required to regulate out a peak value is held for a certain time after a level peak value occurs, if no new level peak value occurs. If no new peak value occurs in or after the peak-hold interval, slow release sets in, so that the attenuation slowly decreases, until either a new peak value occurs, which lies above the AGC threshold, or until the minimal attenuation setting of the attenuation element has been reached.

By setting the parameters of the AGC concept accordingly, it can be guaranteed for all level scenarios that despite an AGC threshold just barely below full-scale of the ADC, clipping of the ADC will almost never occur.

The proposed receiver design, based on the concept of direct sampling, provides a maximum of flexibility and configurability because of a great measure of functions that are presented only by means of software, particularly in all cases in which parallel reception of several channels is desired. It is characterized, as compared with known forms of direct sampling, by a simple structure of its analog part, which can be implemented in cost-effective manner, because of the sensible choice of sampling frequency.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a block schematic diagram of a conventional heterodyne receiver;

FIG. 2 is a block schematic diagram for improving the linearity ahead of the input of an analog/digital converter;

FIG. 3 shows a fundamental representation of a block schematic diagram of a reception system according to the invention;

FIG. 4 shows a block schematic diagram of a reception system according to the invention, having improved linearity;

FIG. 5 shows a block schematic diagram of a reception system according to the invention, having two analog/digital converters;

FIG. 6 shows a block schematic diagram of a reception system according to the invention, having one analog/digital converter;

FIG. 7 shows a block schematic diagram of a “digital” antenna as an application of a reception system according to the invention;

FIG. 8 shows a block schematic diagram of an antenna diversity system using for example four antennas and four broadband digitization input paths for a reception system concept;

FIG. 9 is a block schematic of the invention in the form of a direct-sampling receiver for AM and FM in combination with analog tuners for the integration of additional services and frequency ranges;

FIG. 10 is a block schematic of the invention in the form of a direct-sampling receiver for AM and FM in combination with analog tuners for the integration of additional services and selected frequency ranges with reduced requirements regarding the ADC (12, 12′) for minimal interference due to aliasing; and

FIG. 11 a combination of the invention with a low-effort antenna switching diversity concept for optimization of the signal quality, particularly of a narrow-band reception band or a single channel.

### DETAILED DESCRIPTION

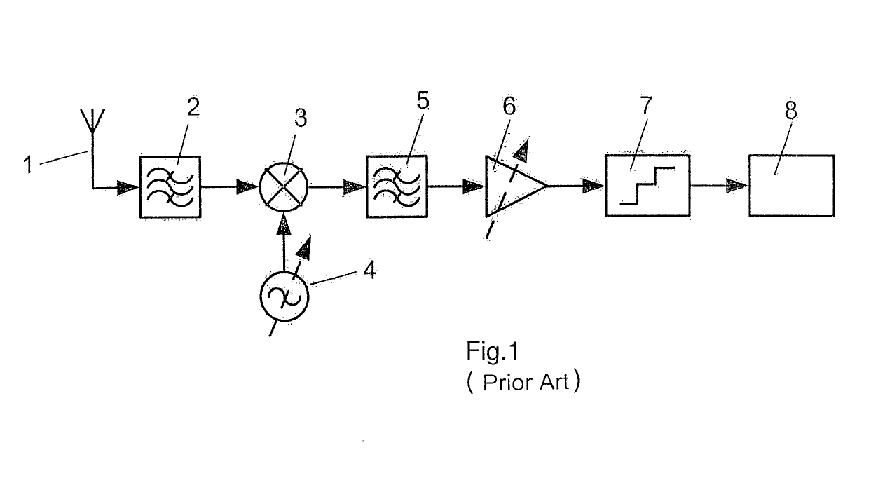

Referring in detail to the drawings, FIG. 1 shows the schematic of a conventional heterodyne receiver. The reception signal is fed to an antenna 1, which is connected to a filter 2 that is used as a mirror-image suppression filter. The output of filter 2 is coupled to a mixing stage 3, in which the signal is mixed with the frequency of a local oscillator 4. This is set in that way, that the desired channel is shifted to a fixed intermediate frequency (IF), i.e. a frequency that is independent of the reception frequency. A second filter 5, connected to the output of mixing stage 3 is set up for channel selection on the intermediate e-frequency level, and as an aliasing filter for the sampling process of digitalization.

The IF signal is fed to the input of an ADC 7 and the level of the IF signal is regulated by means of an automatic gain control (AGC) 6. At the output of the ADC the digital signal is further converted in a signal processing unit 8. The useful signal is obtained by means of demodulation.

This reception system architecture requires conversion of a reception signal into a fixed intermediate frequency by mixing it with a variable oscillator frequency in the analog domain and subsequent digitalization. This conventional circuit has general deficiencies regarding distortion immunity and the hardware effort increases when multiple signals on different channels shall be received simultaneously.

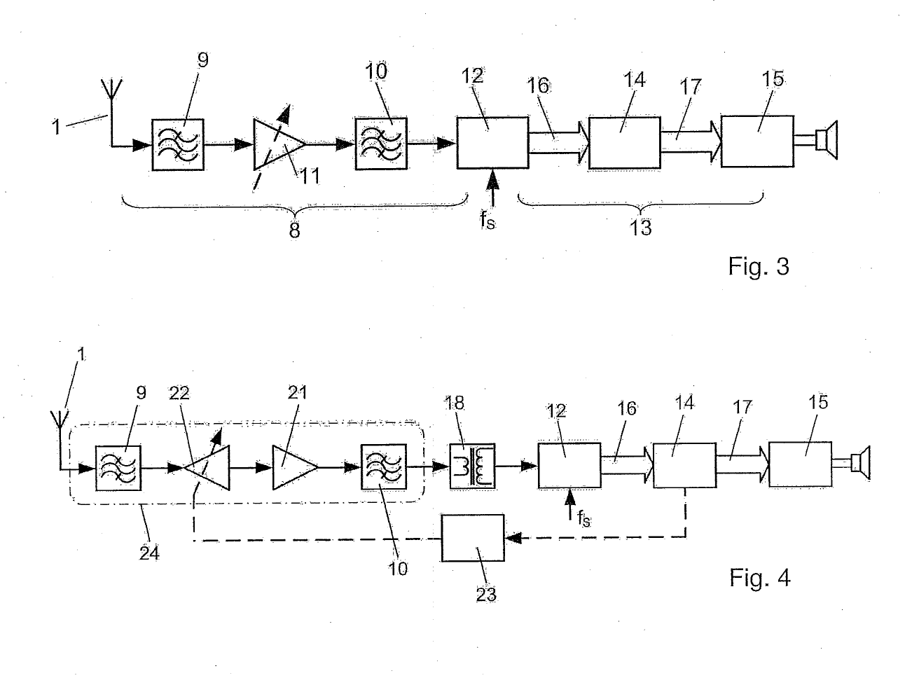

Referring to FIG. 3 there is shown an analog part 8 that is connected to antenna 1 on the input side. This analog part 8 comprises two filters 9, 10, between which a variable gain amplifier 11 is situated which is connected to the two filters 9 and 10. Amplifier 11 can be a single amplifier, but also a cascade of amplifiers. Amplifier 11 is designed so that when measured at the output of the ADC, the noise level produced in a channel of the useful band by the amplifier is less than 10 dB above or even below the noise level produced by the ADC in this channel in the most disadvantageous case. If this demand is fulfilled, a good compromise is achieved between the system sensitivity and the utilization of the dynamic range of the ADC. Filters 9, 10 serve to select the desired useful frequency band coupled in by way of antenna 1. Filter 10 is additionally intended to suppress distortion that lies outside of the received frequency band, but which is produced by the amplifier in front of the filter, such as harmonics or broadband noise, since this distortion would otherwise be incorporated in the subsequent sampling process at the sampling frequency fₛ, and could fold back into the useful signal band (aliasing).

Amplifier 11, or the cascade of attenuation element and fixed amplifier, is designed and controlled so that the amplitude of the analog time signal is regulated at the output of filter 10, or the input of the subsequent ADC 12, so that, in particular, the ADC 12 is not clipped. Amplifier 11 provides decoupling of the two filters 9, and 10, so that their attenuation values add up to a total attenuation.

A digital circuit 13 is coupled to the ADC 12, wherein this digital circuit comprises a digital signal processing unit (DSPU) 14 and a digital/analog converter (DAC) 15. At the output of DAC 15, the useful signal is provided and reproduced in the usual manner. The DSPU 14 takes the data stream 16, with the word width M bits at the frequency fₛ, on its input side, and processes it further. This data stream is demodulated by DSPU 14 and converted into a data stream 17 on the output side, with the word width N bits, which represents the useful signal that is converted into an analog signal in the subsequent DAC 15.

One of the important elements of this concept is the ADC 12, since the overall performance of the total system strongly depends on the ADC's performance, and on the choice of sampling frequency fₛ, in regard to the frequency positioning of the band to be sampled.

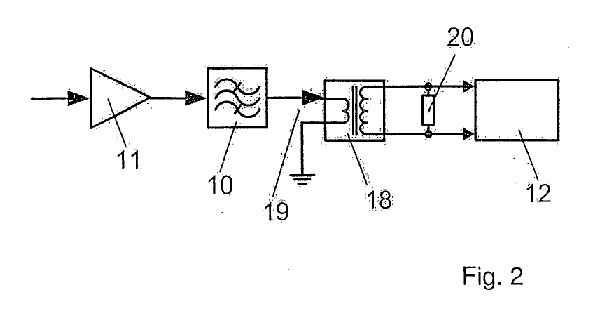

Referring to FIG. 2 there is shown a circuit for improving the linearity at the input of ADC 12, wherein coupled to the input side of ADC 12 a transformer 18 provides impedance transformation (translation ratio from secondary to primary side of t>1) and is disposed between the ADC 12 and the filter 10. On the transformer output side, the ADC 12 is connected in parallel with a termination resistor 20. This means that the voltage levels at the termination resistor 20 differ from the voltage levels at the transformer input by the translation ratio of the transformer 18. In this case, transformer 18 in fact serves as an amplifier in this arrangement. This furthermore means that for a constant input level to the ADC 12, the levels at the amplifier output can be lower by the amplification of the transformer than in the case where the circuit does not use a transformer, or when using a transformer having a 1:1 translation ratio, so that there are less nonlinear distortions generated by the amplifier. Distortions generally increase in the case of a conventional amplifier, the higher the levels are that it has to handle.

Since most transformers have a greater linearity than amplifiers having usual power consumption, in the level ranges that are typical for the ADC input, there is an improvement in the linearity at the input of ADC 12 using the transformer impedance transformation arrangement according to FIG. 2.

A variable amplifier 11 is used in the circuit according to FIG. 3. This can also be replaced, in accordance with the circuit of FIG. 4. In this case, there is a combination of a fixed amplifier 21 with a variable attenuation element 22 that precedes the amplifier in the signal flow direction. The signal line for steering of the attenuation element 22 connects to a digital/analog converter (DAC) 23, which is fed by DSPU 14, in which a digital control variable is generated, which is used to control the measure of attenuation after digital to analog conversion by way of DAC 23.

In FIG. 4, circuit 24 refers to a selection module that selects a desired broad frequency band from the antenna signal and provides it in a level-regulated manner at its output.

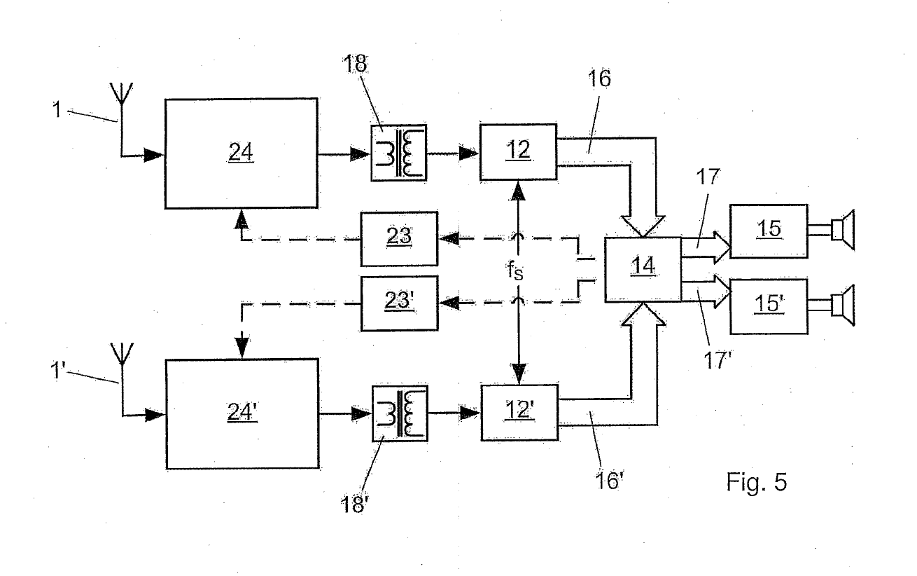

Referring to FIG. 5, there is shown a circuit which is used for the parallel reception of all of the FM and AM radio frequencies. In this case, a first path, having a selection module 24, is set up for the frequency band of 76 MHz to 108 MHz, and a second path, which comprises a frequency selection module 24′, that is configured for the selection of the AM frequency band of 150 kHz to 30 MHz. The structures of the two paths are fundamentally designed in the same manner, so that a fixed amplifier having a prior variable attenuation element as in FIG. 4, is arranged within the selection module, between the two filters. In this case there is a transformer 18, 18′ for impedance transformation and for improving the linearity that is situated ahead of the inputs of the ADC 12, and 12′, in each instance. The two output signals are connected with a DSPU 14, which provides the further processing of the digital data streams that are output by the two ADCs 12, 12′. For example, channel selection and demodulation paths can be provided by DSPU 14, which select and demodulate data from one or multiple AM or FM channels, and output the resulting audio signals by way of the DACs 15, 15′. The number of DAC modules, i.e. of the demodulated channels, can be almost any desired number, and is only limited by the performance capabilities of DSPU 14.

In a manner similar to the circuit of FIG. 4, DSPU 14 generates a digital control variable signal that is fed back to DAC 23 and DAC 23′ which in turn, after digital to analog conversion, is fed into frequency selection modules 24 or 24′ to control the measure of attenuation of the FM- or AM-band signals.

The two ADCs 12, and 12′ of the system shown in FIG. 5 have the same sampling frequency fₛ=130 MHz applied to them. This means that sub-sampling takes place in the FM range, while over-sampling takes place in the AM range.

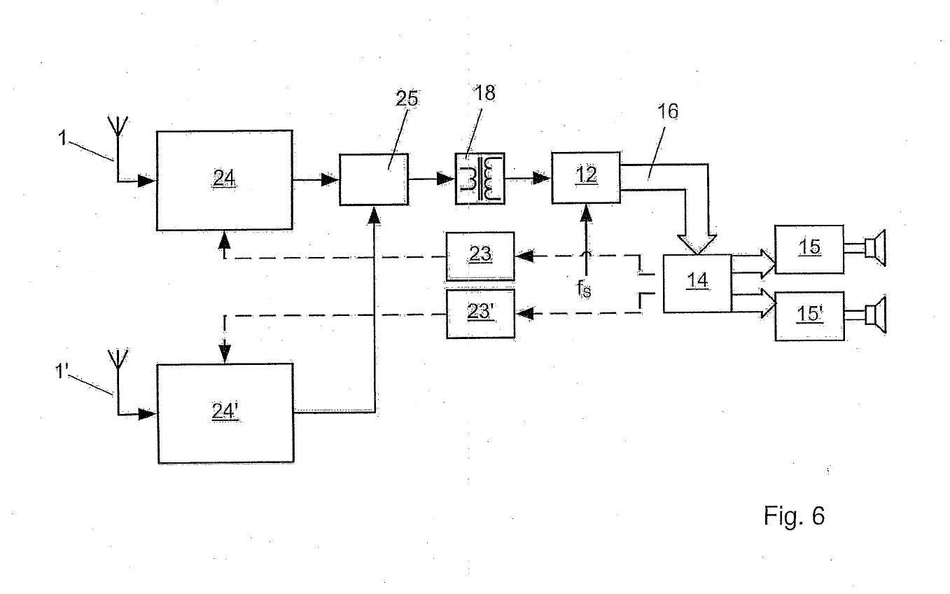

Referring to FIG. 6, there is shown a circuit for digitalization of for example the European ultra-short-wave-band and the AM-band with a single ADC. The circuit includes an upper path, wherein there is a selection unit 24 for selection of the European FM-band, which is coupled to a combiner 25. The second input signal path of the combiner 25 is coupled to the output-side of the selection module 24′ which selects the AM-band. The output signal of combiner 25 is in turn passed on to an ADC 12, that runs at the sampling rate of fₛ=160 MHz, through a transformer 18, for the purpose of improving linearity.

This sampling rate is selected so that the ultra-short-wave FM band is sampled in the manner of sub-sampling, while the AM band is sampled in the manner of over-sampling. With this selection of the sampling rate, it is guaranteed that the best possible protection against aliasing comes about using usual filter characteristics.

The time signals of the two paths are level-regulated separately, in each instance. As compared with the system in FIG. 5, only one ADC 12 is required, which does, however, need a slightly higher sampling rate, so that the hardware expense for the system can be reduced slightly. However, this is achieved at the cost of a lower blocking resistance of the system and slightly reduced protection against aliasing. This principle can also be used if the entire global ultra-short-wave radio band is to be sampled directly.

Frequency selection modules 24 and 24′ also receive from DACs 23 and 23′ attenuation signals in the same way as described in explanation to FIG. 5.

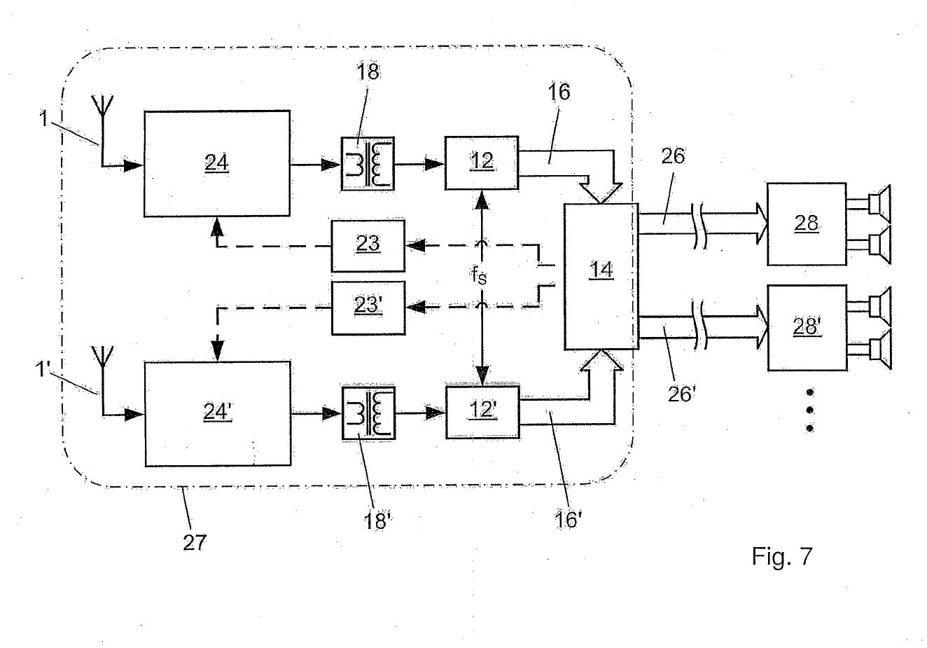

Referring to FIG. 7 there is a system concept depicted that clarifies the basic idea of the “digital antenna”. In this case there is an example given for the entire ultra-short-wave radio band and for the band of all AM services. The entire digital-antenna module is referred to as 27, whereby the signals of one or more antennas 1, 1′ are converted to digital data by means of direct sampling, specifically according to the invention, so that the modules that lie ahead of the DSPU 14, seen in the signal flow direction, correspond to those described in FIG. 5, 6. In the present arrangement, however, the output signals of DSPU 14 are passed to one or more digital data buses 26, 26′, by way of which the output signals of the digital antenna 27 are distributed further to one or more terminals 28, 28′.

The digital data passed on by way of the data buses 26, and 26′ can pass either parts, i.e. individual channels, or partial bands, or also the entire bands that are directly sampled by digital antenna 27, on to the terminals. In the latter case, all of the FM and AM radio services would be available simultaneously and in parallel at each of the terminals 28, and 28′, for the example shown, so that each terminal could demodulate, i.e. evaluate and output any desired number of channels, in parallel, by means of several tuners implemented by means of software.

Digital antenna 27, as shown, therefore provides a maximum of flexibility and configurability, since all of the additional functions past the output of the digital antenna are defined only by means of software, and the entire useful band is available in digital form.

If DSPU 14 outputs only partial bands, individual channels, or demodulated signals or the like, single or multiple selection paths must be implemented on DSPU 14. In order to give each of terminals 28, and 28′ access to the total useful band, namely the entire FM and AM radio band, these selection paths must be configurable by means of control signals from the terminals 28, and 28′.

For this case, the digital data bus 26, and 26′ is set up bidirectionally, in each case, and it may have a lower capacity, since only parts of the output data of digital antenna 27 are transmitted by way of the data bus, in each case. Here, the high degree of flexibility that the digital antenna 27 offers is traded in for reduced demands on the transmission capacity of the digital data bus.

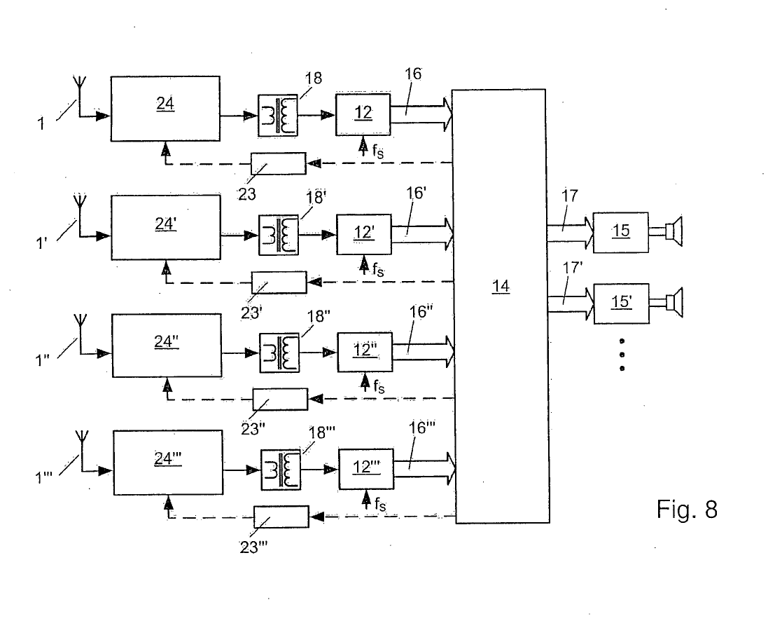

Referring to FIG. 8 there is shown an antenna diversity concept having four antennas 1, 1′, 1″, 1′″, so that there are at least four input paths, in total, of which each individually corresponds to a single path as shown in FIG. 6.

In the case of previous receivers, diversity concepts according for example to the “switch-diversity” principle were used, in which the signal strength or signal quality in the channel is used as the criterion for the current selection of an antenna. In this arrangement, the useful band of each connected antenna 1 to 1′″ is separately subjected to direct sampling, and is passed to the DSPU 14 in digitalized form, in each instance. The diversity functionality can then be presented by means of software, whereby for each channel to be received, this channel is selected from the antenna signals, which is now present in digitalized form, and combined or switched in accordance with the diversity concept. In this case, the tuner or tuners are also provided on DSPU 14 by means of software.

Because of the presentation entirely by means of software, this diversity concept thus offers a maximum of flexibility and great freedom in the use of digital algorithms and optimizations, on the basis of direct sampling.

It is true that the system shown in FIG. 8 relates to a diversity system for the global ultra-short-wave radio band, having four input antennas and two tuners presented by DSPU 14. This system has two audio outputs for demodulated signals. However, the principle can fundamentally be expanded to any desired number of bands and any desired number of antennas having a number greater than 1, and accordingly, any desired number of “software” tuners.

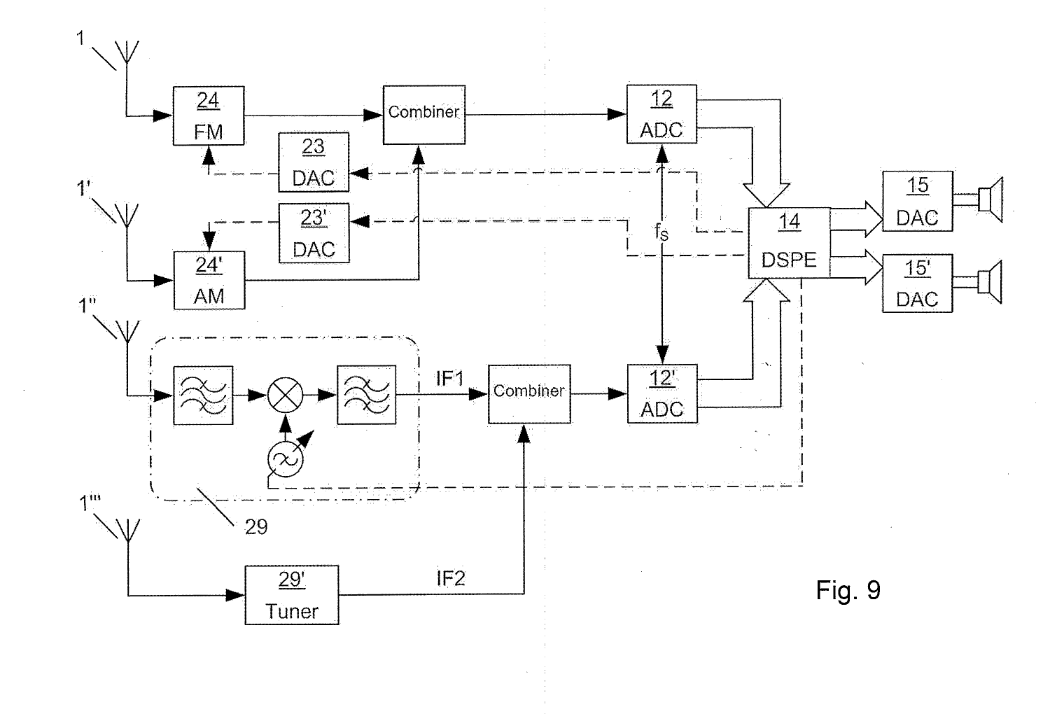

In the following, reference is made to drawing FIG. 9, which represents a combination of the invention with analog tuners, for the integration of additional services and frequency ranges.

For frequency ranges for which direct sampling is not economical and efficient because of the limited performance capacity of today's ADCs, the direct sampling concept can be combined with conventional mixing concepts. In this connection, efficient utilization of the ADC dynamic range, as optimal as possible, is essential for the idea of the invention.

In the representation according to FIG. 9, the useful bands to be directly sampled (here: AM and FM bands) of the antennas 1, 1′ are selected in broadband manner in the selection modules 24, 24′, and combined in the combiner 25, to produce a single input signal for the ADC 12. In the simplest case, the combiner consists of a direct combination of input and output lines. The sampling rate fₛ of the ADC is selected in such a way that the FM band is sub-sampled, as provided by the invention (frequency position in the 2^{nd} Nyquist zone) and the AM band is super-sampled.

For integration of additional frequency bands, signal frequency bands are converted to one or more intermediate frequencies (IF1, IF2) by the antennas 1″, 1′″, by means of one or more tuners 29, 29′. These intermediate frequency signals are combined by means of a combiner 25′, and sampled in another ADC 12′ or another ADC channel. If the intermediate frequencies are suitably selected, and if the selection of the intermediate frequency signals is sufficient, the result is achieved that simultaneous digitalization of the intermediate frequency signals is possible, without any significant aliasing influence. The use of multiple similar tuners offers the possibility of antenna switching diversity and phase diversity, or simultaneous reception of multiple channels or services on different frequencies. The evaluation of the signals on the intermediate frequencies takes place, as in the case of direct sampling, by means of multiple digital tuner paths implemented on the DSPU 14, by means of which paths simultaneous evaluation of the channels directly sampled in the ADC 12 is also possible.

An expansion of this concept to additional bands and ADC channels is also an object of this invention. For example, a further directly sampled FM band can be passed to the ADC 12′, parallel to the two tuner paths 29, 29′, by way of the combiner 25′, for the implementation of antenna diversity or phase diversity. Alternatively, integration of further bands to be sampled directly can also take place by way of one or more additional ADCs or ADC channels.

It is also possible to pass this band on to the DSPU by way of another ADC or ADC channel.

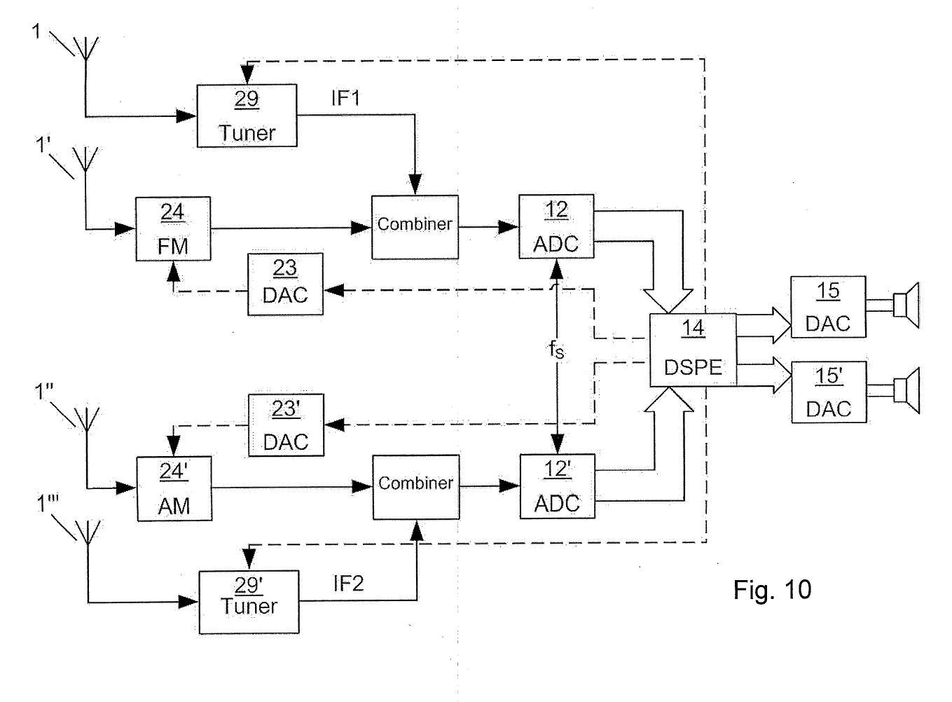

In the following, reference is made to drawing FIG. 10, which represents a combination of the invention with analog tuners, for the integration of additional services and frequency ranges, with optimized frequency range utilization of the ADCS.

As compared with the representation from FIG. 9, the two intermediate frequency signals (IF1, IF2) and the output signals of the selection modules 24, 24′, which signals are to be sampled directly, are now not passed to the same ADC or ADC channel, but rather, they are divided up between the two ADCs 12, 12′, and passed to the ADC, in each instance, by means of a combiner 25″, 25′″, in each instance. Since the intermediate frequency signals for the reception of individual channels are usually narrow-band signals, as compared with the directly sampled band, better utilization of the available ADC input frequency range is made possible. At the same aliasing protection as in the arrangement in FIG. 9, the required sampling rate fₛ of the ADCs for the arrangement according to FIG. 10 can be reduced.

For this conceptual approach, as well, an expansion to further ADCs or ADC channels, or further intermediate frequency signals and direct-sampling bands, is included in the idea of the invention.

Also included in the idea of the invention is the use of change-over switches instead of combiners. For such an arrangement, increased aliasing protection is achieved, at the cost of a loss of the ability to simultaneously receive the signals passed to the switch (or combiner, respectively). Implicitly, such behavior can also be achieved by way of lowering, i.e. additionally damping the levels in the analog tuners and/or the selection modules, while keeping the combiners.

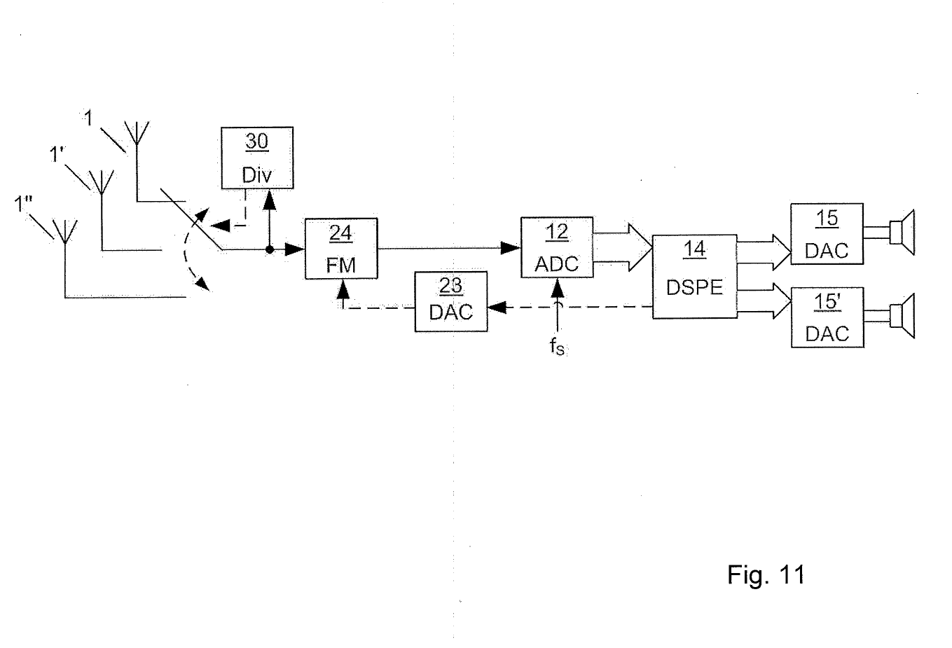

In the following, reference is made to drawing FIG. 11, which represents a combination of the invention with an antenna switching diversity.

Of multiple antennas 1, 1′, 1″, only one antenna at a time is passed to the direct-sampling receiver consisting of the selection module 24, (here: set up for FM reception), the ADC 12 having the sampling frequency fₛ, the DACs 23, 15, 15′, and the DSPU 14, by way of a switch 31. The logic for switching between the antennas is integrated into the diversity module 30. Alternatively, this logic can also be contained in a digital implementation in the DSPU, in which an evaluation of the digitalized reception signal takes place, on the basis of which a switch between the antennas occurs.

This concept makes reception signal optimization by means of antenna switching diversity possible for a limited frequency band, i.e. for a single channel, and this is sufficient for many application cases. In contrast with a direct-sampling receiver with phase diversity for all reception channels, for which the complete useful band must be directly sampled at least twice, the hardware expenditure for this antenna switching diversity concept is clearly reduced, since the useful signal is only sampled once. This antenna switching diversity concept can be expanded to all the forms of the invention presented until now, which are thereby also an object of this invention.

Accordingly, while only a few embodiments of the present invention have been shown and described, it is obvious that many changes and modifications may be made thereunto without departing from the spirit and scope of the invention.

What is claimed is:

1. A reception system, comprising:
an analog part designed to accept and pass through a complete broadband reception band;
a digital part connected to the output of said analog part and having at least one analog/digital converter (ADC 12) which is set for sampling, the output band of said analog part, as determined by sampling frequency fₛ;
wherein said output band comprises a useful band limited by an upper frequency fₘₐₓ and a lower frequency fₘᵢₙ, and relative upper and lower transition bands b_{tr,up}, b_{tr,low}, wherein said sampling frequency fₛ is preset so that the useful band with cutoff frequencies fₘₐₓ and fₘᵢₙ is sub-sampled in that manner, that the useful band lies completely in a second Nyquist zone, which means that fₛ>fₘₐₓ and fₛ/2<fₘᵢₙ.

2. The reception system as in claim 1, wherein a set of relative bandwidths of the upper and lower transition bands b_{tr,up} and b_{tr,low} are equal so that said sampling frequency fₛ is dimensioned as fₛ=fₘᵢₙ+fₘₐₓ/2.

3. The reception system as in claim 1, wherein said analog part comprises at least one selection module set for producing a band-limited, level-regulated analog signal on the selection module's output side.

4. The reception system as in claim 3, wherein said selection module comprises
at least one filter and
an amplifier coupled to said at least one filter, wherein said amplifier can be regulated.

5. The reception system as in claim 3, wherein said selection module comprises at least one filter, a fixed amplifier coupled to said at least one filter, and an adjustable attenuation element coupled to said amplifier.

6. The reception system as in claim 3, wherein the amplifier in the selection module is dimensioned so that in a channel of the useful band, the amplifier generates a noise level at the output of said analog to digital converter, which lies less than 10 dB above or below the noise level generated by said analog to digital converter ADC in this channel.

7. The reception system as in claim 6, comprising a transformer coupled to the input side of said analog to digital converter, for improving the linearity of said input signal.

8. The reception system as in claim 1, wherein said digital part comprises at least one digital signal processing unit (DSPU), and at least one digital to analog converter (DAC).

9. The reception system as in claim 8, wherein said digital signal processing unit DSPU is set for the selection of channels or larger frequency bands from the useful band on the input side.

10. The reception system as in claim 8, wherein said digital signal processing unit is set up at least for the selection of channels from the useful band on the input side and for demodulation.

11. The reception system as in claim 10, further comprising at least two reception modules that are designed to accept and pass through different reception bands, and that are connected to said DPSU by way of said analog to digital converter, wherein the output part of said DSPU presents data streams having a demodulated signal in each instance.

12. The reception system as in claim 10, wherein there are at least two selection modules each set up for accepting and passing through different reception bands, and that are connected to said digital signal processor unit (DPSU) by way of a combiner and an analog/digital converter (ADC) wherein an output of said DPSU provides data streams having a demodulated signal, in each instance.

13. The reception system as in claim 8, wherein a plurality of reception modules are each set up for coupling in a complete reception band, and are coupled to said DSPU by way of said analog to digital converter (ADC) in each instance.

14. The reception system as in claim 13, wherein an input side of said DSPU is set for the connection of x signal paths, each having an antenna and wherein an output side of said DSPU provides y data streams, having demodulated signals.

15. The reception system as in claim 8, comprising at least two selection modules for coupling to different reception bands, and which are connected to said DSPU by way of said analog to digital converter, wherein the output of said DSPU provides multiple data streams that represent the complete reception band.

16. The reception system as in claim 11, wherein there are a plurality of analog to digital converters which each have a common frequency fₛ applied to them.

17. The reception system as in claim 4, wherein said digital part comprises at least one digital signal processing unit (DSPU) and at least one digital to analog converter (DAC), and wherein said digital signal processing unit is coupled to and regulates the gain of said amplifier.

18. The reception system as in claim 5, wherein said digital part comprises at least one digital signal processing unit (DSPU) and at least one digital to analog converter (DAC), and wherein said digital signal processing unit is coupled to and controls said adjustable attenuation element.

19. The reception system as in claim 17, further comprising at least one analog tuner; at least one additional antenna; at least one additional analog to digital converter and at least one combiner;
wherein partial signal bands of said at least one additional antenna can be converted to one or more output signals by means said at least one analog tuner, and can be passed to said at least one additional analog to digital converter or ADC channels by means of said combiner.

20. The reception system as in claim 19, wherein said output signals of said at least one analog tuner are distributed among the outputs of a plurality of analog to digital converters or ADC channels, and combined with directly sampled signal bands, in each instance, and passed to an analog to digital converter (ADC) or ADC channel and combined together, or in a switched manner.

21. The reception system as in claim 20, further comprising at least one change-over switch, wherein the output signals of a plurality of antennas can be passed to the input of said selection module by means of said change-over switch.

22. The reception system as in 21, wherein said change-over switch can be controlled via an evaluation in a diversity module implemented in an analog manner.

23. The reception system as in claim 21, wherein said change-over switch can be controlled on the basis of an evaluation of the digitalized signal in said digital signal processing unit (DSPU).
